(19) United States
(12) Patent Application Publication
(10) Pub. No.: US 2015/0012888 A1
(43) Pub. Date: Jan. 8, 2015

(54) F&I MENU SYSTEM

(71) Applicant: ITAP MENU, LLC, Carmel, IN (US)

(72) Inventors: Michael WILSON, Carmel, IN (US); Ozan SELCUK, Carmel, IN (US); Shawn McCOOL, Carmel, IN (US); Scott BEARDSLEY, Carmel, IN (US)

(21) Appl. No.: 14/334,355

(22) Filed: Jul. 17, 2014

Related U.S. Application Data
(63) Continuation of application No. 13/494,613, filed on Jun. 12, 2012.
(60) Provisional application No. 61/496,854, filed on Jun. 14, 2011.

(51) Int. Cl. G06F 3/0481; G06F 3/0484; G06F 3/0482

(52) U.S. Cl. CPC G06F 3/04817; G06F 3/0482; G06F 3/04842; G06Q 40/00
USPC 715/835

(57) ABSTRACT

An F&I Menu system for the sale of a product that is financed and which includes multiple options. A display shows the base price of the product without optional items, and a with-options price. Icons representing optional items may be moved between unselected and selected areas. As the icons are moved into or out of the selected area, the with-options price is instantaneously updated, including any price changes resulting from the application of pricing components reflecting the costs of financing or leasing.

### RELATED APPLICATION

This application is a continuation of application Ser. No. 13/494,613, filed 12 Jun. 2012 that claims the benefit of provisional application No. 61/496,854, filed 14 Jun. 2011, which are incorporated herein by reference.

### FIELD OF THE INVENTION

The present disclosure relates to systems used to present purchase options to purchasers in connection with the sale of vehicles or other products having multiple optional features.

### BACKGROUND

F&I Menu selling refers to the finance and insurance (F&I) portion of a vehicle acquisition transaction in which, along with the financing terms of the transaction (whether sale or lease), the vehicle dealer provides to the vehicle purchaser/lessee a number of options a menu of additional products and services that the purchaser can choose to include into the vehicle purchase transaction. For example, an F&I menu might include optional items such as extended warranty products, paint and exterior protection, anti-theft registration, pre-paid maintenance, identity theft protection, tire and wheel protection, door ding protection, etc. For a sale or lease of a product like a cell phone, a F&I menu, (or optional items) might include, extended warranty plans, data access plans, roaming plans, international calling or roaming plans, loss or theft insurance, cloud or other data storage services, etc.

In the context of vehicles, some F&I menu systems allow the vehicle dealership finance manager to create one or more static options, which are then presented to the vehicle purchaser either on paper or on a computer screen. The purchaser can then select from these options the products and services that he or she wishes to add. If the purchaser wishes to change the terms of the financing agreement or to select options that aren't presented on the finance manager's pre-created menu, the finance manager must go back to the F&I system to adjust the offered menu options and re-present the new options to the purchaser.

Existing F&I menu systems often result in salespersons failing to consider presenting to a customer all the items that could be offered to a customer. Many F&I menu systems are clumsy and slow to use, because they do not instantly calculate the selected menu items being considered by a customer. Instead, it takes time for a salesperson to calculate the cost of items selected by a customer. This does not allow a customer to immediately see the cost of various menu options. This can result in the customer becoming frustrated with the menu section process. In addition, existing menu systems do not allow an organization to require, or encourage, that one or more specific menu items be presented to each customer. Existing systems also do not facilitate a customer quickly and easily getting more detail about specific menu offerings.

### SUMMARY OF THE INVENTION

An F&I Menu system is disclosed that it provides interactivity between the finance manager/salesperson and the purchaser. Directly on a mobile device such as a tablet computer, the finance manager and the purchaser can adjust the options that are presented and the options that are selected for inclusion with the vehicle purchase, how the prices of these options appear (the total price of the option or the option's impact on the financed payment), the financing terms (the number of months, the type of transaction (lease, financing, cash, etc.), and more. Selections and adjustments can be made in real time by the purchaser, and the pricing and financing calculations are adjusted by the system in real time on the screen. When the purchaser makes final selections, the F&I menu system records the transaction, captures the signatures, and facilitates printing of a summary of the selections made. A vehicle purchaser has control over the information that supports his or her purchasing decisions for F&I products and services.

### BRIEF DESCRIPTION OF THE DRAWINGS

FIG. 1 shows an F&I menu system before any F&I menu items are selected, and with six recommended F&I menu items.

FIG. 2 shows an F&I menu system with five of 8 options selected.

FIG. 3 shows vehicle cost information before any F&I menu items are selected.

FIG. 4 shows how F&I menu items may be selected by dragging associated icons from an all-options display area to a selected display area, and how the vehicle cost or amount financed information is instantly updated to reflect the selected item.

FIG. 5 shows how selecting an additional (third) F&I menu item further instantly updates the vehicle cost or amount financed information.

FIG. 6 shows a screen that can be accessed by clicking on the “Amount Financed” button of FIGS. 1-5, and in which an initial payment amount may be interactively changed.

FIG. 7 shows the use of slider bar to change the amount of an initial payment, and the corresponding instantaneous change to the vehicle cost or amount financed information.

FIG. 8 shows how further alteration of the initial payment results in further instantaneous change to the vehicle cost or amount financed information.

FIG. 9 shows an F&I menu system configured to display different combinations of F&I menu items, and their associated costs.

FIG. 10 is another embodiment of an F&I menu system before any F&I menu items are selected.

FIG. 11 shows how additional information regarding an F&I menu item may be displayed in response to user input, for example, by tapping on the icon for the optional item.

FIG. 12 shows the display of even “more” information about a particular F&I menu item.

FIGS. 13 and 14 shows the display of a window for displaying a video clip describing a particular F&I menu item.

FIG. 15 shows the display of a window for displaying additional pricing information for a particular F&I menu item.

FIG. 16 shows the display wherein an icon for an optional item is being dragged from an unselected options area (on the far left) to a selected options area, but before the dragging is complete, and how the base price area at the top (displayed a base price in the format of an amount financed of $24,615.20) matches the base cost of the product in the with-options price area in lower right corner.

FIG. 17 shows how the selected options area may appear after the icon for the selection option item icon of FIG. 16 is fully dragged, and how the base cost of the product in the with-options price area in lower right corner has been automatically updated (including recalculation of interest) so that the updated price can be compared to the cost in the base price area.

FIG. 18 shows how the selected options area may appear after a second option item icon is fully dragged into it, and how the base cost of the product in the with-options price area in lower right corner has been further automatically updated (including recalculation of interest) so that the revised updated price can be compared to the cost in the base price area.

FIG. 19 shows another embodiment for displaying a selected options area labeled “accept” and an unselected options area labeled “decline,” and in which no “recommended” options are displayed, and, means for displaying two signature areas and capturing handwritten signatures.

FIG. 20 shows a captured signature.

FIG. 21 shows a menu building screen of a back-end system whereby a salesperson may select what options and features a customer will see on the system.

FIG. 22 shows a pricing screen that may be displayed in response to user input for the icon, in this case, depressing the icon for five seconds, to allow a salesperson user to change the price of the optional item.

### DETAILED DESCRIPTION

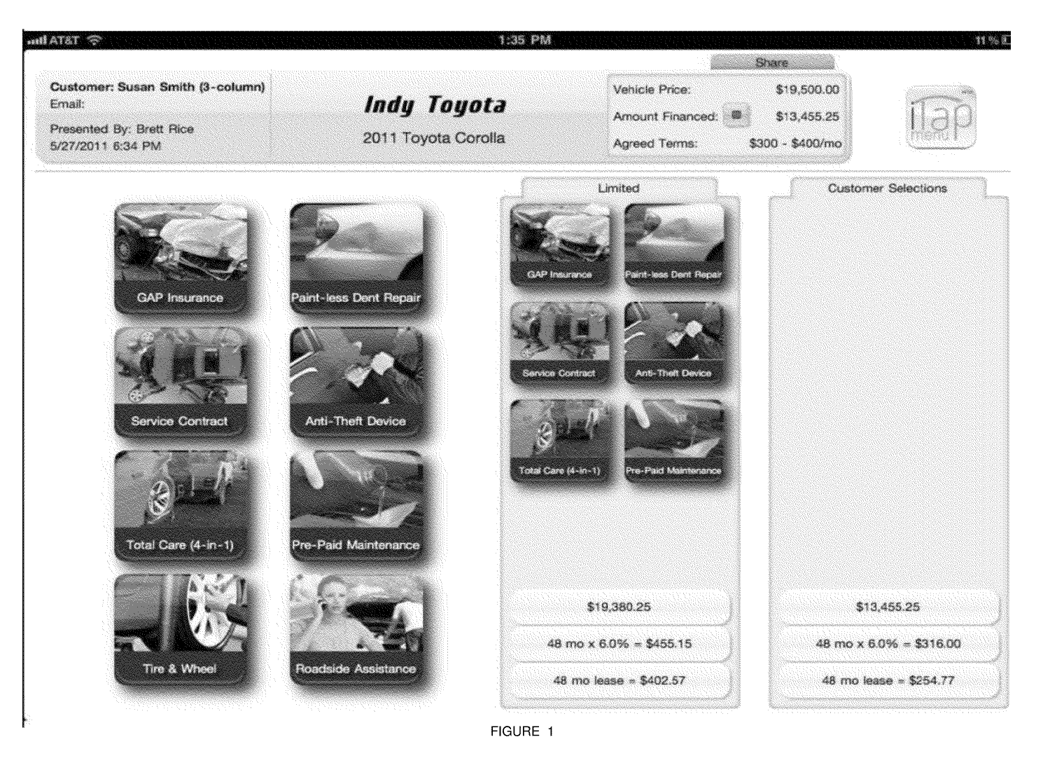

FIG. 1 shows an F&I menu system before any F&I menu items are selected, and with six recommended F&I menu items. The visual user interface has three main areas. On the left is an all-options or unselected options area displaying icons of a plurality of unselected F&I menu icons for a vehicle. Each F&I icon is associated with a F&I menu item that has a price associated with it. In the center is a predetermined subset area capable of displaying copies of a subset of the plurality of F&I menu icons. In this case, a subset of six icons for “recommended” optional items are shown. On the right is a selected options area for displaying selected F&I menu icons. In FIG. 1, the selected area is blank.

The visual display also includes three price areas. The base price area shows the base cost of a vehicle, in this case, shown as “Vehicle Price: $19,500.” This represents the price without any F&I menu items. In this embodiment, this area also shows the amount financed. The bottom of the predetermined cost display area displays the cost of the subset of the plurality of F&I menu items represented by the F&I menu icons in the predetermined subset area. In this example, six such icons are shown. The cost is expressed in three formats: total cost including the price of the vehicle, the cost assuming the car is financed over a specified term and interest rate, and the cost for monthly lease payments if the car is leased. (All costs are net of the down payment, as discussed further below). The bottom of the selected area also shows these same types of costs. However, as no F&I menu options have been selected, the vehicle cost is the same as that shown in the base price area.

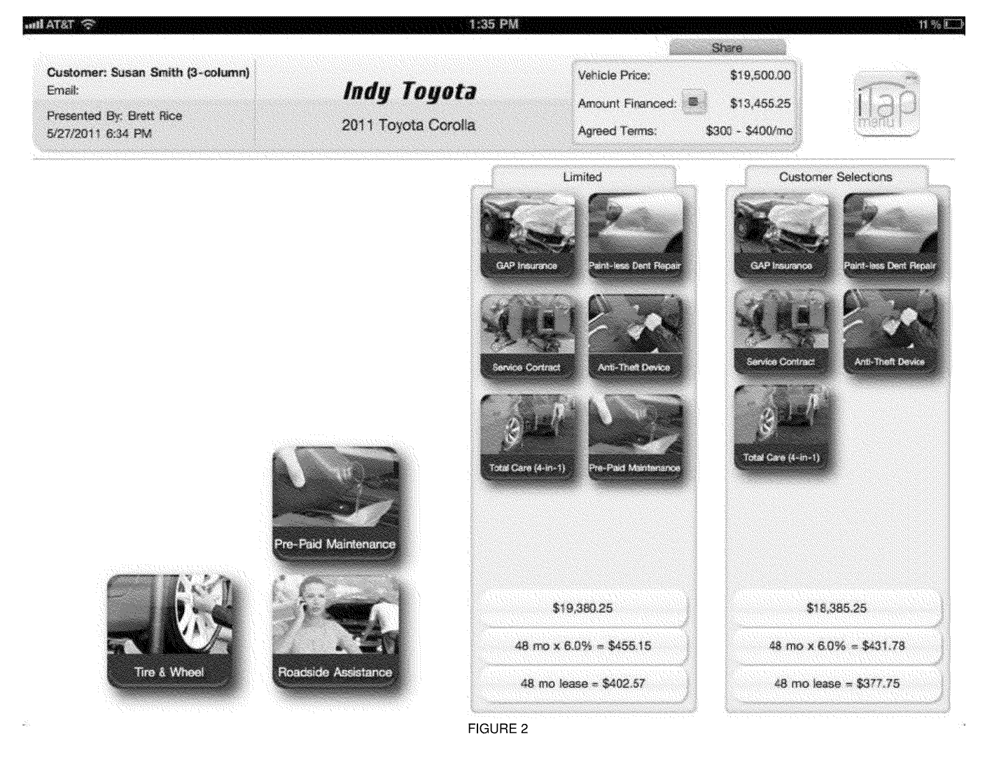

FIG. 2 shows an F&I menu system with five of 8 options selected. The selection process is described below. However, what is noteworthy is that the displayed cost of the selected F&I menu items has been instantly updated to reflect their total cost (inclusive of the vehicle). The updated prices are shown below the selected area.

It will be appreciated that the subset of the plurality of F&I menu items in the predetermined subset area remain static, as does their cost. This allows a customer to easily compare the cost of selected menu items to recommended menu items. Having the costs of recommended and selected menu items simultaneously visible, with the selected item costs being instantly updated, significantly reduces the time to select menu items, and increases the customer's satisfaction with the purchasing process.

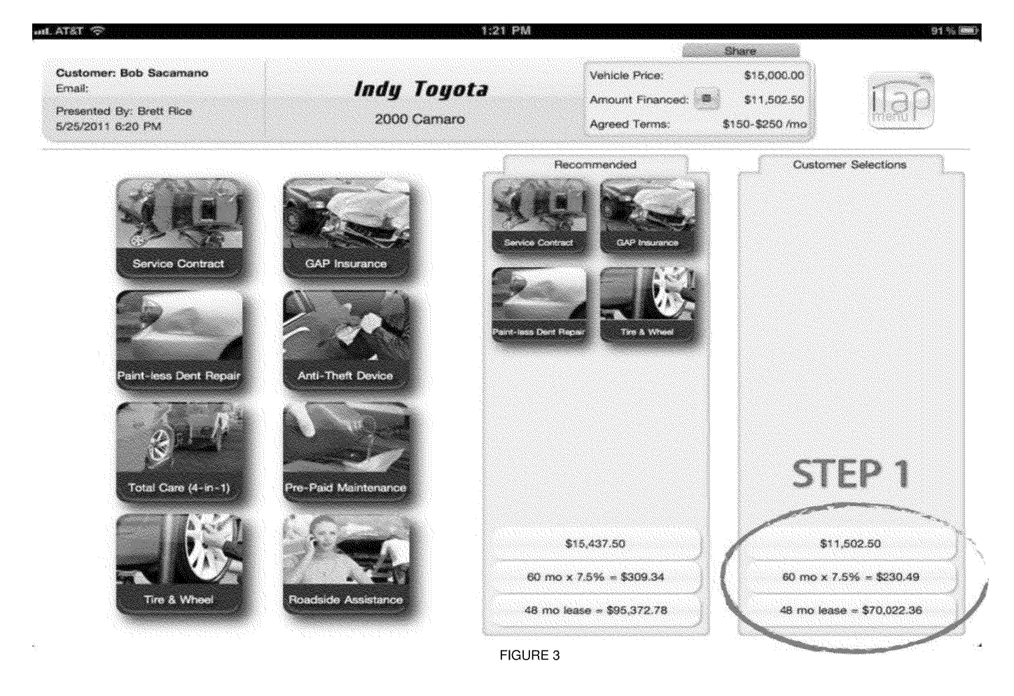

FIG. 3 shows vehicle cost information before any F&I menu items are selected. This is for a different vehicle than that shown in FIGS. 1-2. Because no F&I menu items have been selected, the costs shown as STEP 1 reflect just the vehicle (after applying the initial payment). In addition, three formats for the cost with options are shown, namely, a fixed (or up-front cash) amount; a periodic payment according to a first set of payment terms, namely a 60 month lease at 7.5% interest, or a 48 month lease.

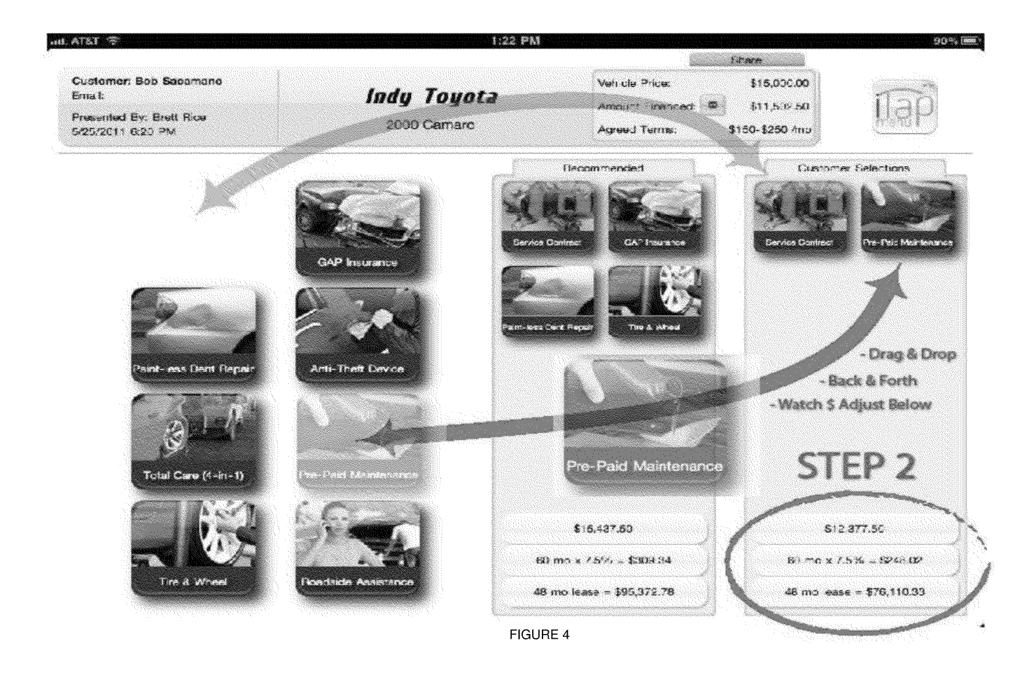

FIG. 4 shows how F&I menu items may be selected by dragging associated icons from the unselected or all-options area to the selected options display area, and how the vehicle cost information is instantly updated to reflect the selected item. The customer is free to add and remove F&I menu items as they see fit. In FIG. 4, two F&I items have been moved from the all-options area to the selected area, and the cost information has been instantly updated to reflect the two F&I menu items.

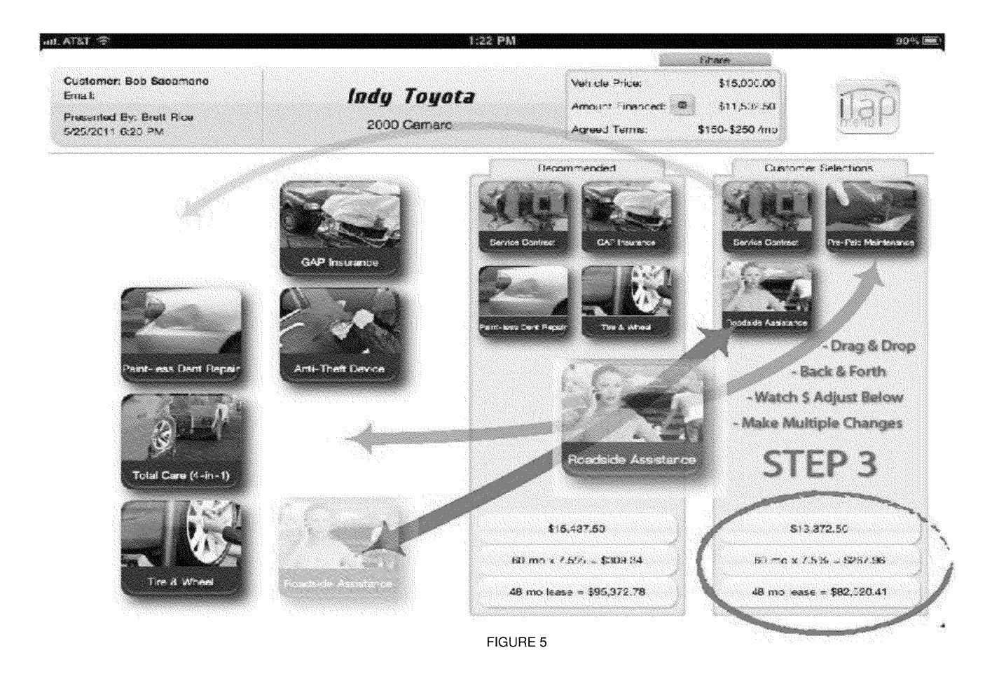

FIG. 5 shows how selecting an additional (third) F&I menu item further instantly updates the vehicle cost information. The selection of F&I menu items may be accomplished based on the capabilities of the user interface. In one embodiment, a tablet such as an Apple IPad is used, and F&I menu items may be selected by touching and dragging them between the all-options and selected areas. However, a user interface may also provide for selections to be made using a mouse, voice command, eyeball tracking, or any form of user interface. In addition, other options for selection items instead of dragging icons may be to simply tap the icon, or to depress it for a predetermined time period, such as three seconds. For such an embodiment, a visual indicator may be made that the icon has been selected, such as by surrounding it with a colored frame. In addition, applying the same action to the icon can deselect it.

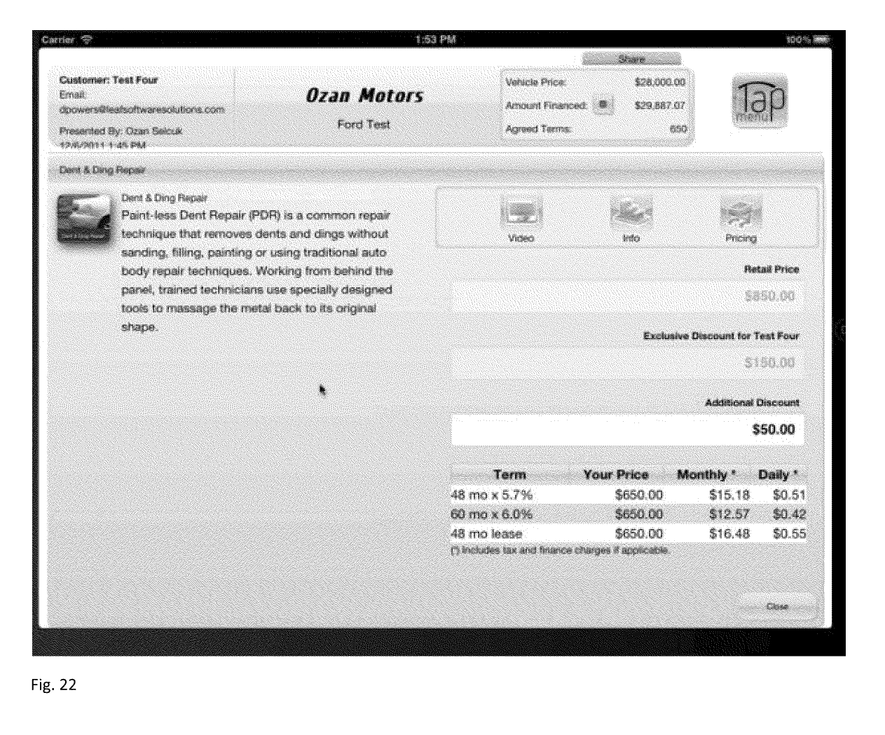

Moreover, optional item icons may be subject to different types of actions. For example, a salesperson may encounter price resistance to a customer purchasing a particular optional item. Thus, the salesperson may wish to offer the customer a “special deal,” but at the same time, not let the customer know in advance that a special deal is available. Thus, a “hidden” method for offering a special deal may be to configure the icons so that if they are subject to non-evident action, such as pressing the icon continuously for 5 second, that a special screen pops up such as that shown in FIG. 22. This screen has an option for specifying an “Additional Discount” which may be factored in the cost calculations, which may result in the customer electing to purchase the optional item.

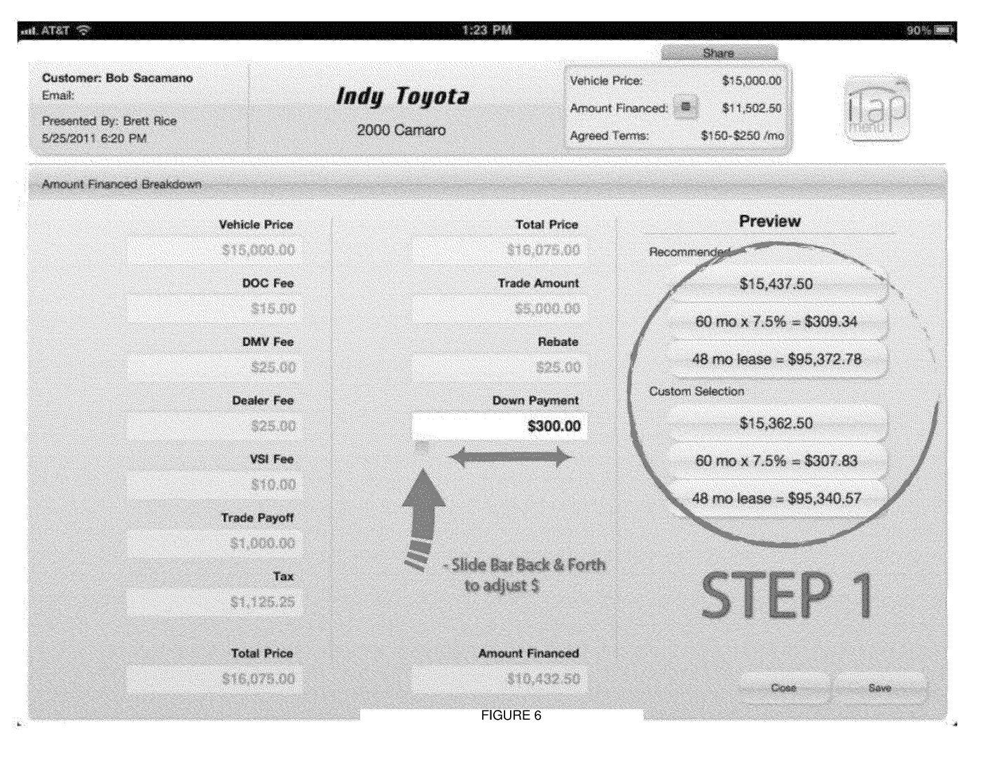

One variable for the cost in purchasing a vehicle is the amount of the initial or down payment. This may be altered by selecting the yellow button next to the “Amount Financed” on FIGS. 1-5. This displays the screen in FIG. 6, which may show basic information about the vehicle purchase. Usually, this information will have been entered into a back-end system, and the dimmed information shown in FIG. 6 (such as the vehicle price) cannot be changed via this user interface. However, one variable the customer is able to change is the Down Payment (or “initial payment”). This change may be made by use of any suitable user interface device, such as slider bar. As shown in FIG. 6, the slider bar is at the far left, and represents a minimum down payment of $300. The associated cost for Recommended and Selected F&I menu options are designated as STEP 1.

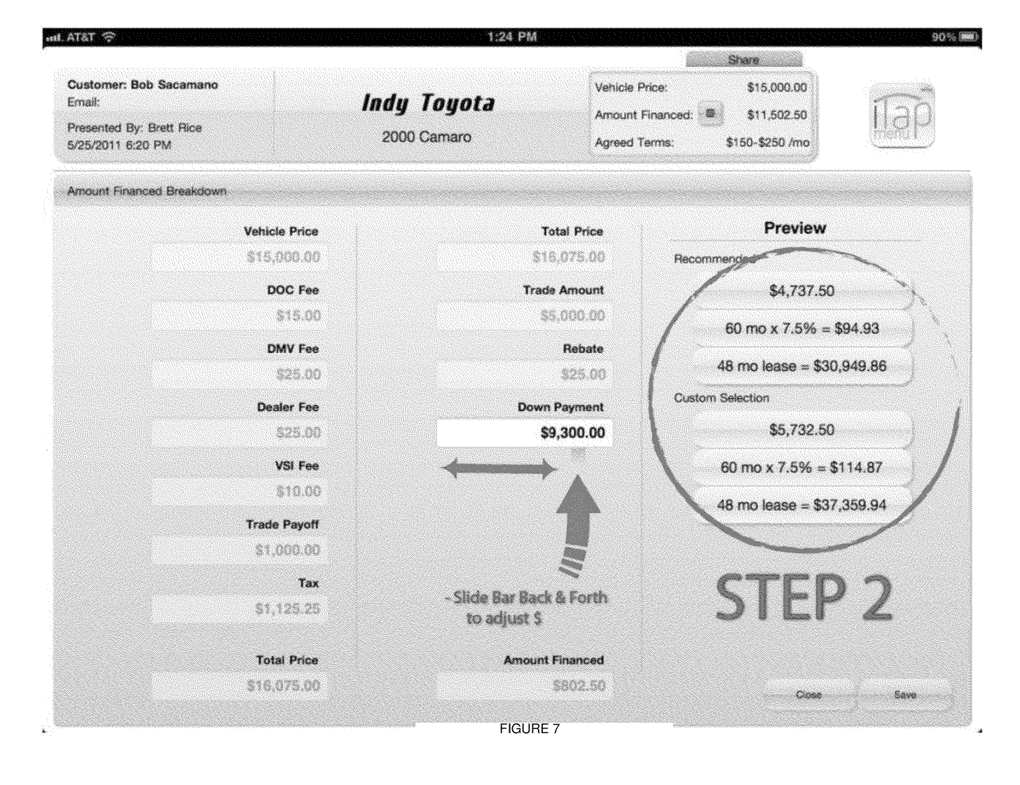

FIG. 7 shows the use of slider bar to change the amount of an initial payment, and the corresponding instantaneous change to the vehicle cost information. Here, the slider bar is moved to the right such that the initial payment is increased to $9,300. Below this amount, the Amount Financed has been decreased to $802.50, and as shown as STEP 2, the total costs for the Recommended and Selected F&I menu items have also decreased.

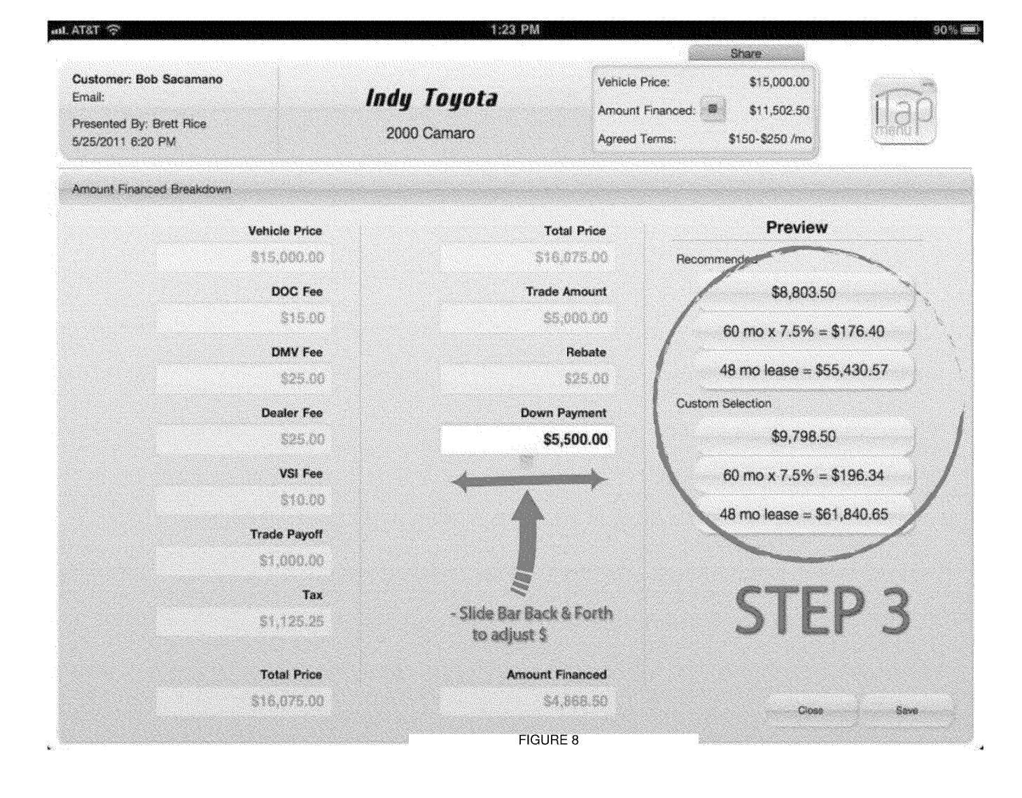

FIG. 8 shows how further alteration of the initial payment results in further instantaneous change to the vehicle/F&I menu item cost information. As will be appreciated, this down payment of $5,500 is between the down payments shown in FIGS. 6 and 7. Consequently, the F&I menu item costs shown as STEP 3 are also between those shown in FIGS. 6 and 7.

The formulas for calculating the costs of various F&I menu items and factoring periodic payments and interet are well known in the art and do not form a part of the invention per se. Some F&I menu items, such as gap insurance, may be affected by the Amount Financed, while others, such as the cost for prepaid maintenance will not. In addition, the calculations for determining finance or leasing payments are known in the art. Also, those of skill in the art will appreciate that any other user interface device for specifying a price could be used in lieu of a slider bar, such as a text input box, radio buttons, etc.

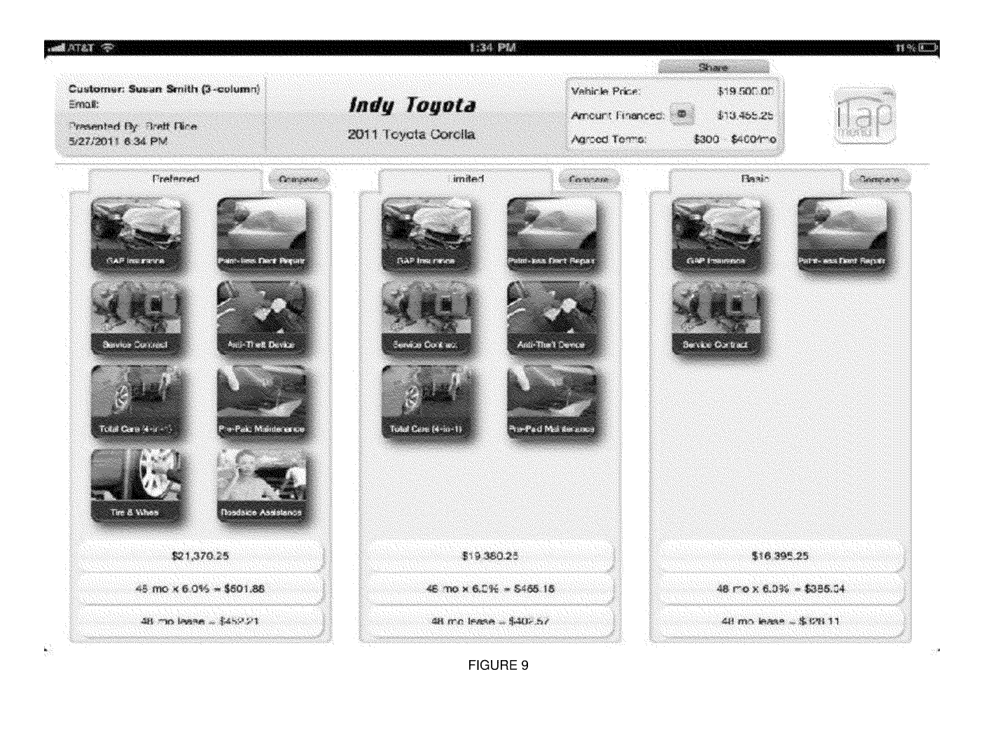

FIG. 9 shows an F&I menu system configured to display different combinations of F&I menu items, and their associated costs. For some customers, a sales person may prefer not to give a customer unlimited control of F&I menu options. Therefore, the disclosed system may include the option of specifying multiple (in this case, three) predetermined selections of F&I menu options. The price of each is shown, and the customer is not given the option to customize the offerings. This feature is particularly helpful for customers who have a difficult time making a decision. Presenting such customers with fewer options has the beneficial effect of minimizing the time required to make a final selection. Optionally, the various predetermined selections may be presented as Gold, Silver and Bronze packages, or some other designation denoting total value.

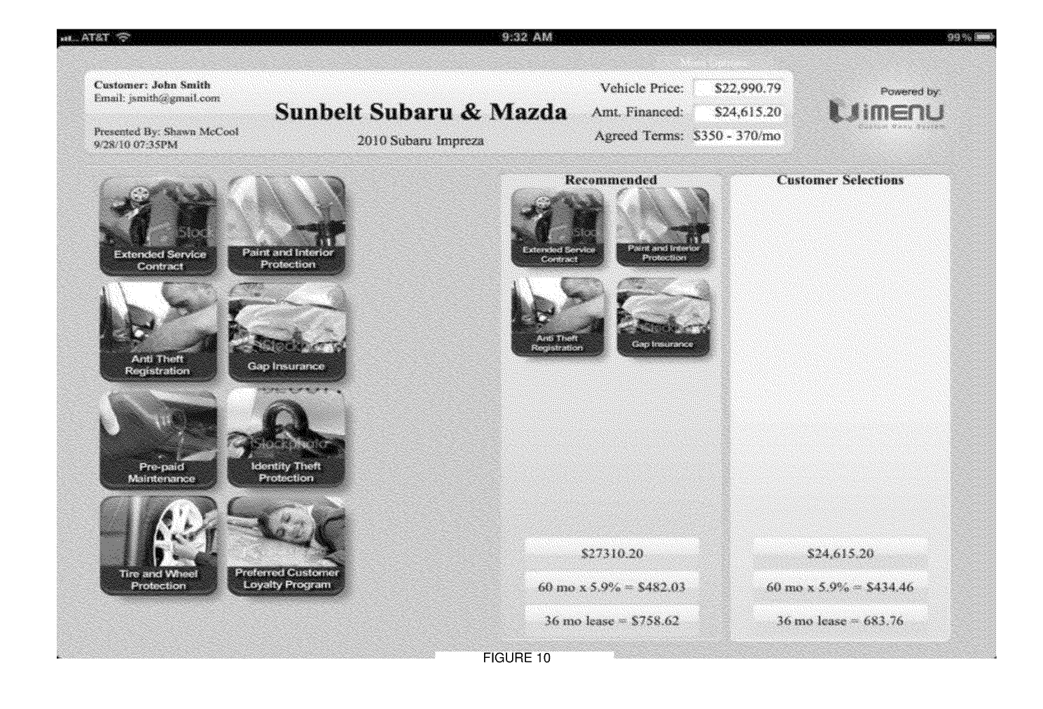

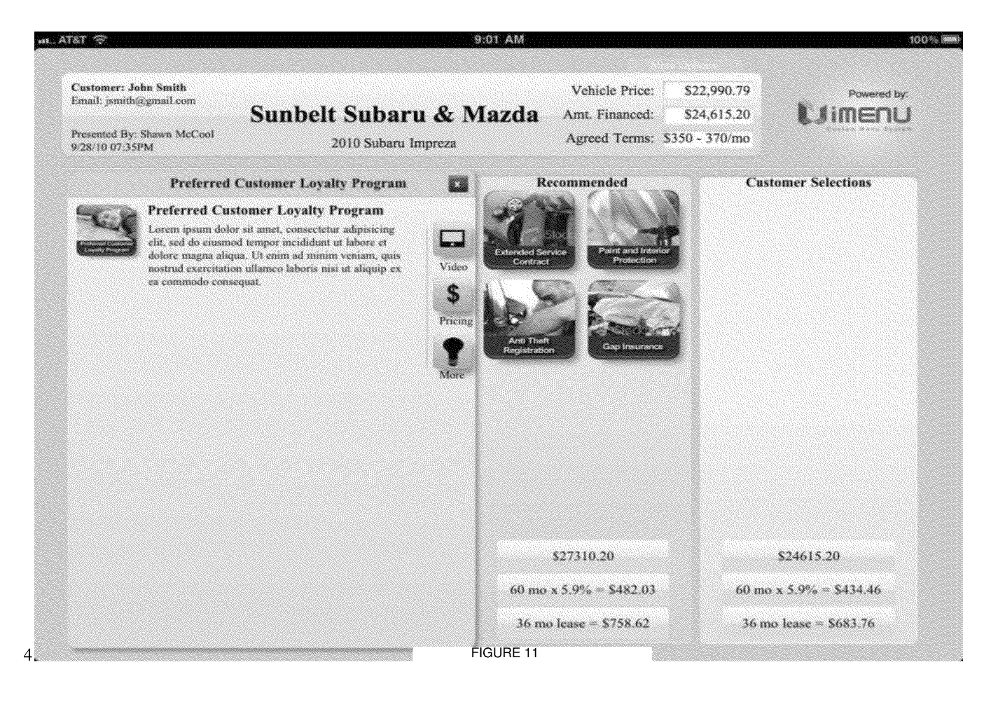

The disclosed system also includes the capability to obtain more detailed information regarding a particular F&I menu option. FIG. 10 shows another embodiment of an F&I menu system before any F&I menu items are selected. By double-tapping a F&I menu icon (or using another icon-selecting user interface method such as pressing for 5 seconds), further information may be displayed. For example, if the “Preferred Customer Loyalty Program” F&I menu icon is selected, the window shown in FIG. 11 may be displayed.

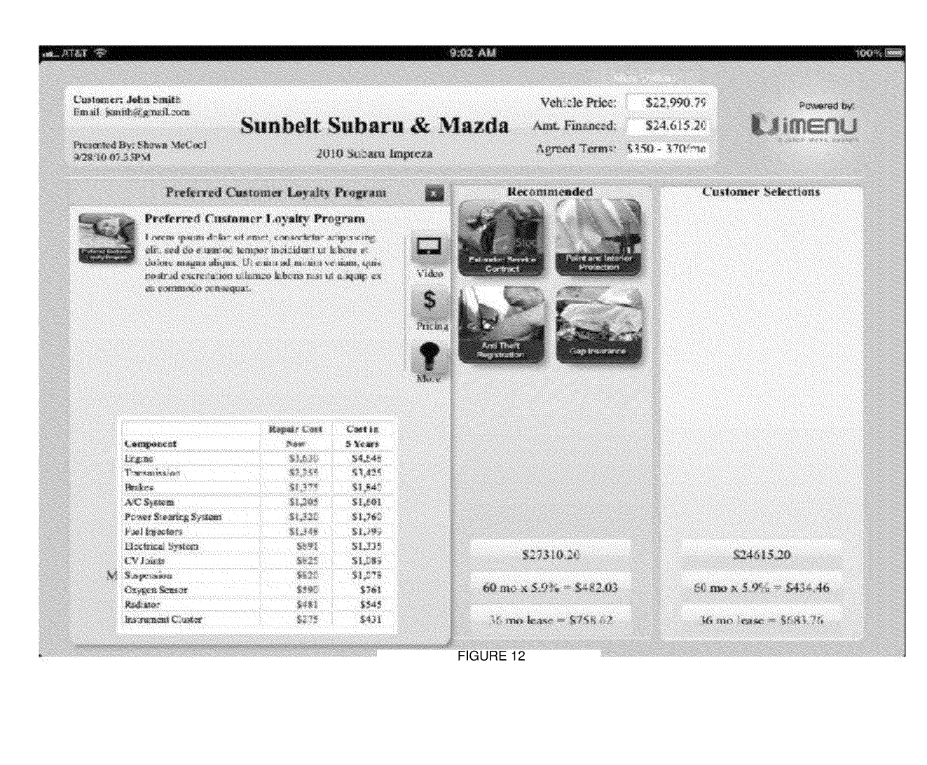

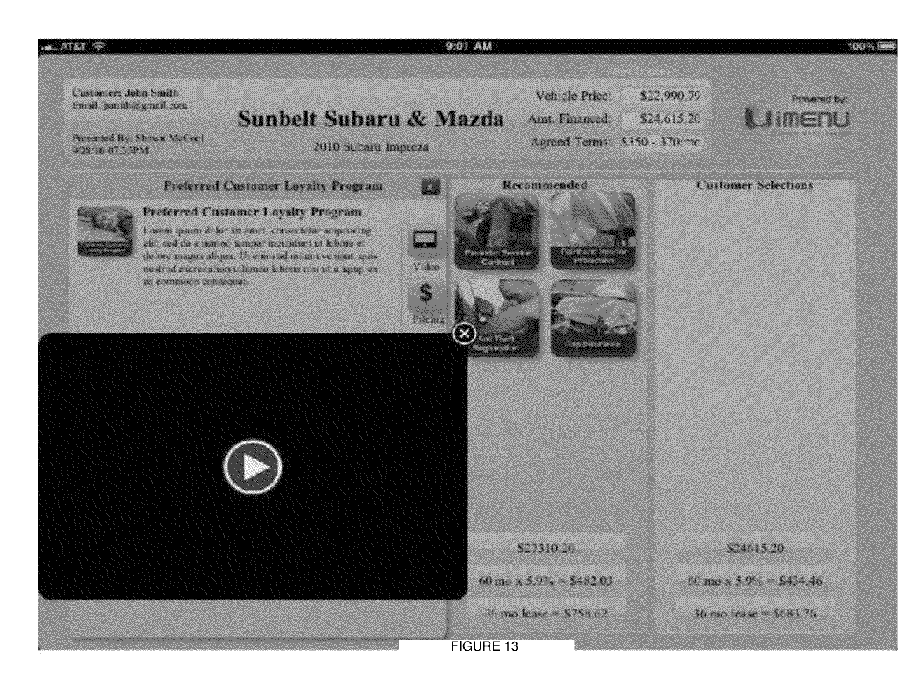

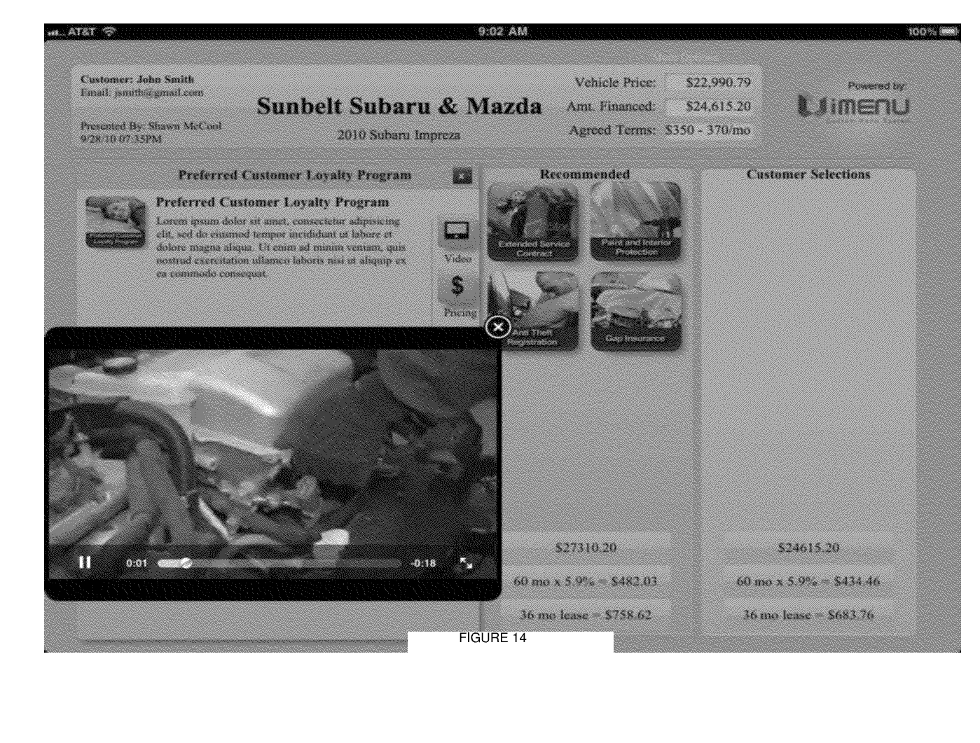

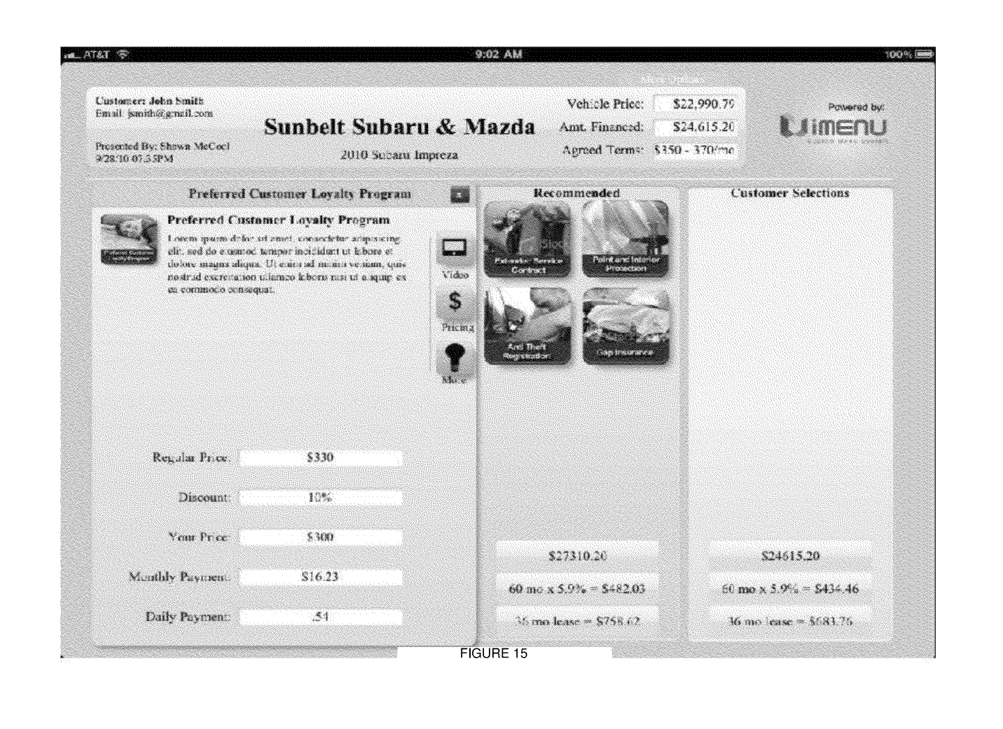

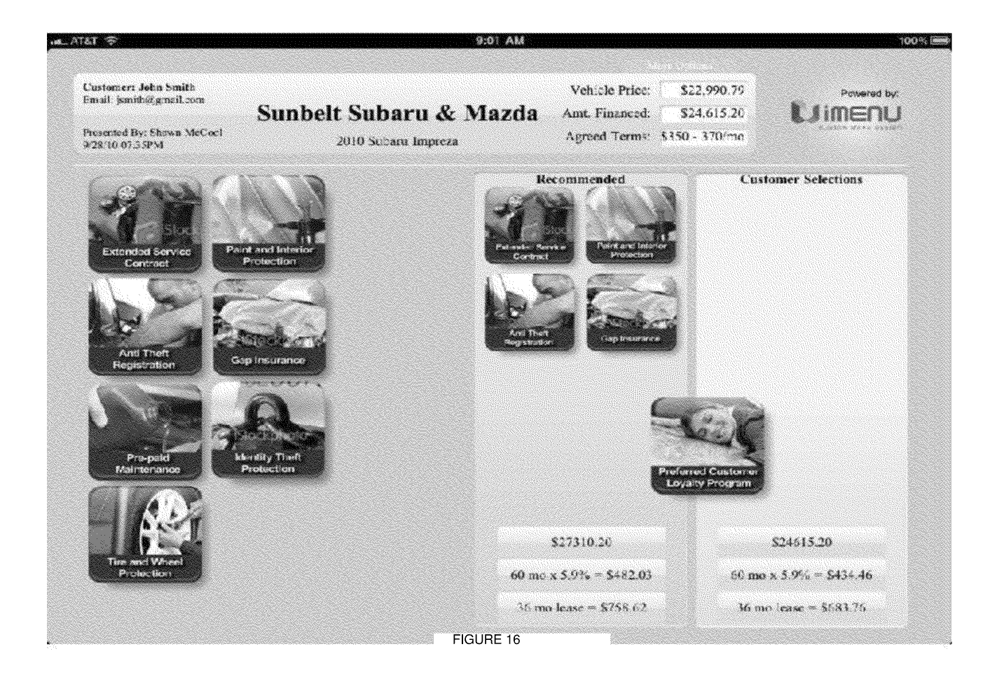

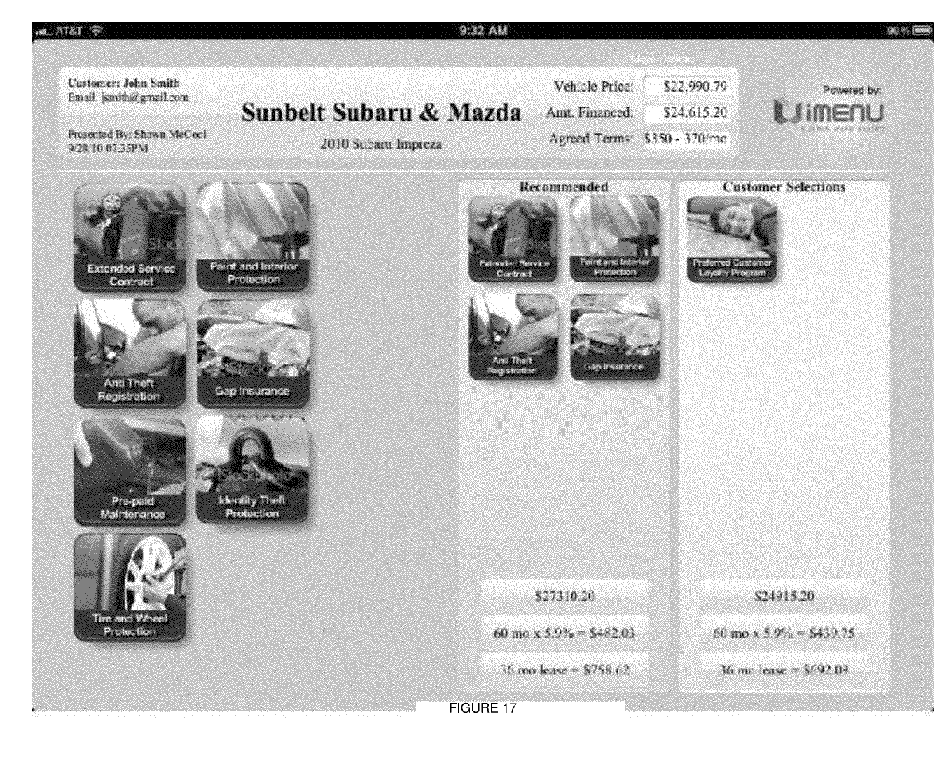

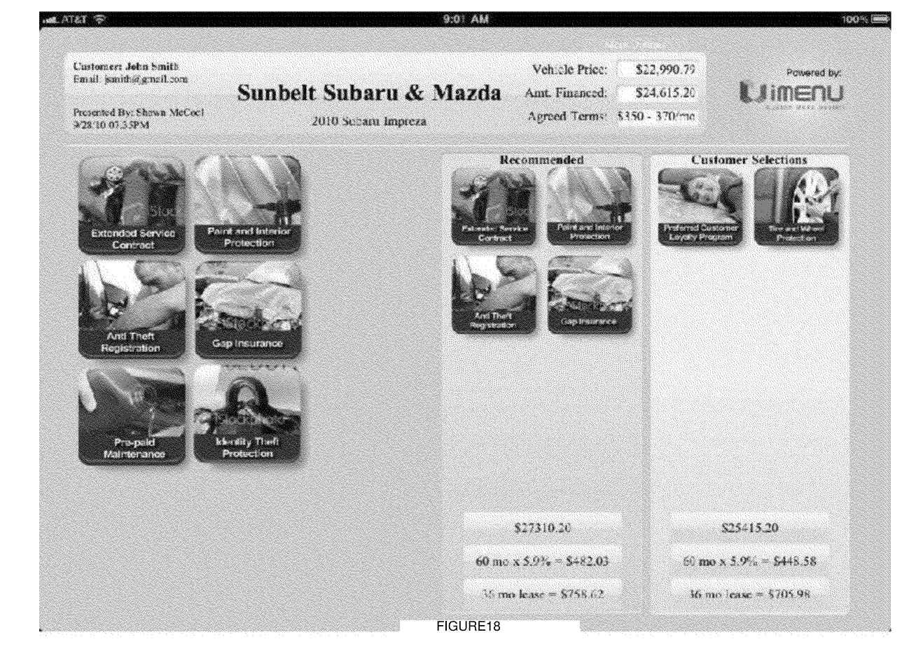

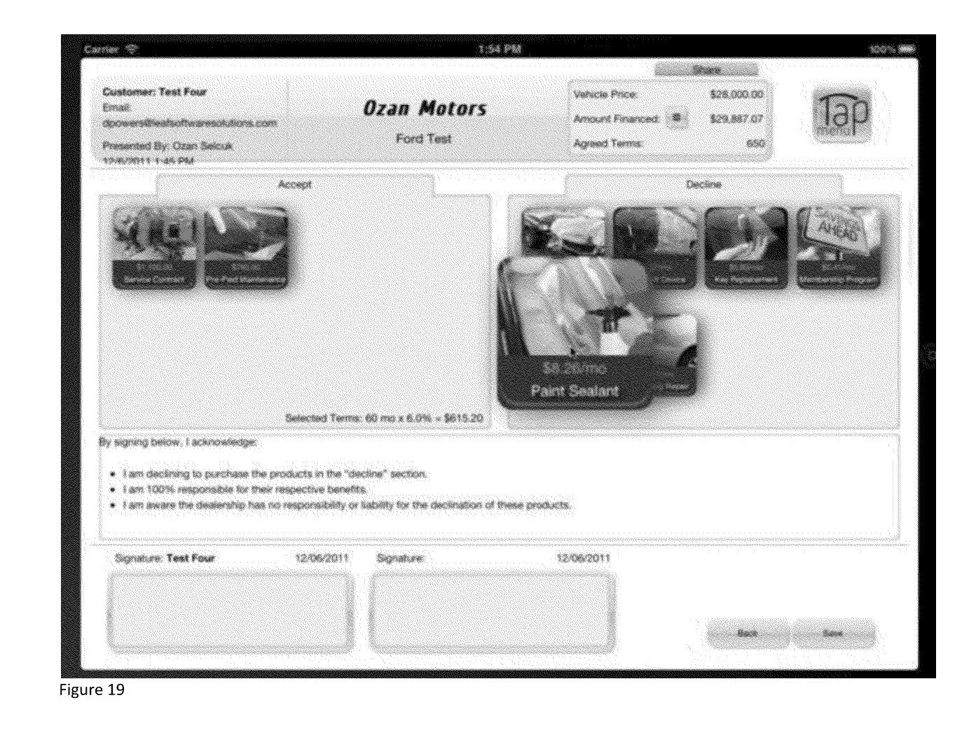

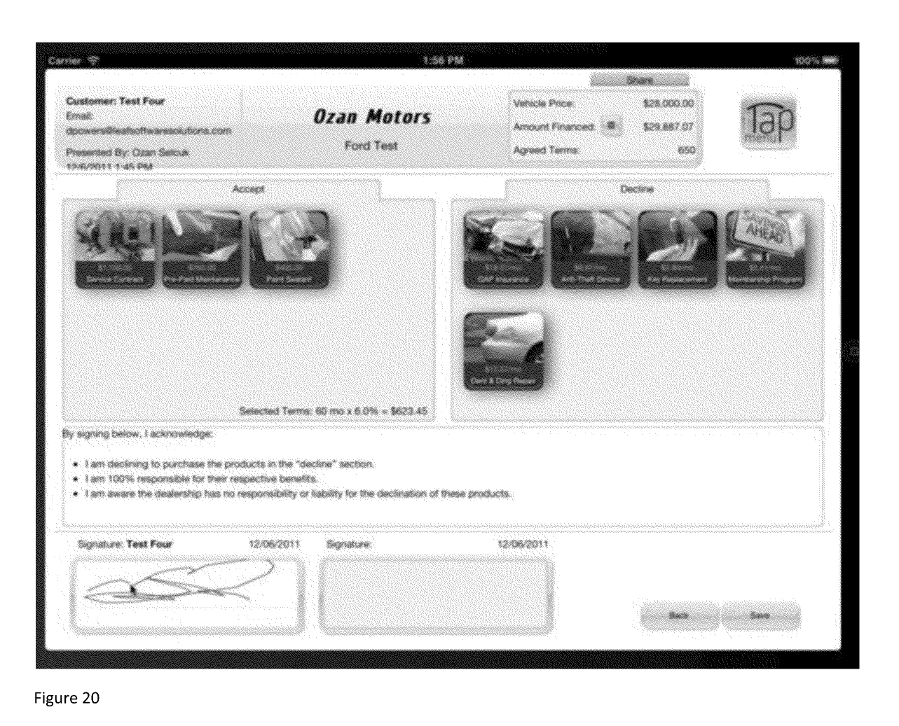

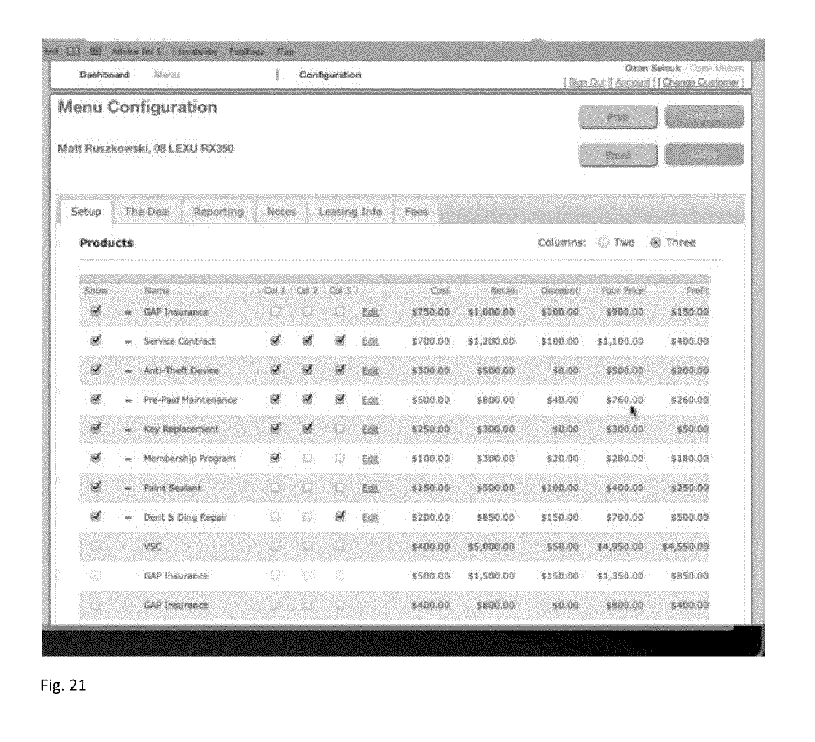

FIG. 11 shows how additional information regarding an F&I menu item may be displayed by selecting the item. In one embodiment, a brief textual description of the F&I menu item is displayed. In addition, the customer may view further information by selecting the Video, Pricing or More options. Representative embodiments for displaying this additional information are shown in FIGS. 12-15.

Systems for storing information regarding customers, product offerings and the calculation of vehicles financing terms are known in the art and not part of the present invention per se. In one embodiment, databases may be stored on the Internet (in “the cloud”) and accessed remotely via a wireless, web-based client device such as an IPad or tablet computer.

Those of skill in the art will understand that various details of the invention may be changed without departing from the spirit and scope of the invention.

As used in this specification and the claims, the term “purchase” or “purchaser” and variants thereof refers not just to a purchase, but to any other transaction in which a person may acquire use of an object via an agreement, such as by lease or rental. Also the term “icon” refers to any visual indicia, whether a picture, a graphic, or text.

As used in this specification and the claims, the term “F&I menu item” or “optional item” refers not just to a transaction involving a vehicle, but to any type of product or service that is an optional, add-on purchase item in connection with the sale, lease or rental of an underlying product. For example, in connection with the acquisition of a cell phone, F&I menu items could include extended warranty products, data access plans, roaming plans, international calling or roaming plans, loss or theft insurance, cloud or other data storage services, etc. In connection with the rental of a vehicle, F&I menu items could include damage waiver insurance, collision insurance, life insurance, additional driver privileges, pre-paid fuel refilling, GPS rental, etc. In connection with the purchase of a pizza, an F&I menu item could refer to the optional toppings of the pizza, such a sausage, pepperoni, mushrooms, etc. The key is that an F&I menu item or an optional item is always sold in connection with another underlying product, there is only an option to purchase a single instance of the F&I menu item (i.e., the “quantity purchased” is always one), and the cost of the underlying product and the F&I menu item(s) may be bundled together. Because an F&I menu item contemplates the ability to purchase only one quantity of the item, for systems, such a pizza ordering system, in which it may be desired to offer, for example, both sausage and double sausage, this may be accommodated by making these two options separate F&I menu items. In this case, if both the sausage and double sausage items were selected, the customer would in essence be ordering triple sausage.

An F&I menu icon may be selected in multiple ways, such as by: (a) dragging it from the options area to the selected area, causing it to appear only in the selected area and not the options area; (b) dragging it from the options area to the selected area, causing it to be copied to the selected area while the original remains in the options area (in which case it may be de-selected by dragging it back from the selected area to the options area, or perhaps by clicking an “X” which may be displayed on the icon in the selected area; (c) tapping or double tapping the icon, in which case a similar tapping or double tapping may de-select it; or (d) using any other icon-selecting technique which are known in the art.

In the embodiments shown in the drawings, the all-options, predetermined (or recommended) and selected areas are mutually exclusive and each is contiguous. However, it is within the spirit and scope of the invention that such areas may be noncontiguous. For example, a user interface may be utilized in which an F&I icon is selected, by either some means other than dragging to the selected area, such as by tapping (but not moving) the F&I icon (e.g., when tapped, a yellow ring may light up to surround the F&I icon, while tapping again de-selects the icon). In such an implementation, when the F&I icon lights up, the space it occupies on the screen would automatically become a part of the “selected” area, and the cost options would be automatically be updated to include the cost inclusive of the selected F&I menu item.

Moreover the system may wirelessly save transactions in a database, allowing them to be reflected on the dealer's inventory and F&I performance reporting.

The term “base cost” refers to a cost without any F&I menu items. Depending on the implementation, the base cost may either include or exclude various ancillary costs such as taxes on the vehicle, delivery and preparation fees, etc. However, the base cost will not include additional cost of any of the optional F&I menu options/items.

As discussed above, one embodiment of the invention includes the simultaneous display of a base price/cost without any optional items, and with optional items. Moreover, it may be desirable to instantly and automatically update the cost with optional items as they are selected, whether the selection is done by dragging icons to a selected options area, or by some other technique such as by highlighting or un-highlighting an icon each time it is tapped, when the icon is touched for a predetermined time period, such as 3 seconds. A means for automatically updating the base cost of the product with options as item icons are selected may be accomplished through software. Representative software for performing such updating using a drag and drop methodology is:

Code executed when an item is dragged to a selected options area:

customLocationDropped: function (r, e) {

e.preventDefault( );
e.stopPropagation( );
var $product = $(r);
var $customLocation = this.elements.customLocation;
this.elements.customProductList.append($product);
$product.attr(‘style’,

‘’).removeClass(‘origin’).addClass(‘custom’);

var repo = page.repo.productRepo;
var product = repo.all

.where(‘MenuProductId’, ‘=’, $product.attr(‘id’))
.and(‘Available’, ‘=’, true).single( );

product.Custom = true;
if (repo.save(product) == 1) {

page.laneCalculator.update_all( );

}

}

Code executed when an item is dragged out of a selected options area:

originLocationDropped: function (r, e) {

e.preventDefault( );
e.stopPropagation( );
var $product = $(r);
var $customLocation = this.elements.customLocation;
this.elements.menuProductList.append($product);
$product.attr(‘style’,

‘’).removeClass(‘custom’).addClass(‘origin’);

var repo = page.repo.productRepo;
var product = repo.all

.where(‘MenuProductId’, ‘=’, $product.attr(‘id’))
.and(‘Available’, ‘=’, true).single( );

delete product.Custom;
if (repo.save(product) == 1) {

page.laneCalculator.update_all( );

}

}

Code executed to update base cost with options displayed in the with-options area:

It is further contemplated that a displayed cost of a product, both with and without optional items, may be displayed in multiple formats. As such the “cost” may be interpreted to include or exclude interest. In addition, the “base” cost may be displayed in a number of different formats, such as an up-front payment, or monthly periodic payment, or a combination of both. In addition, cost may be expressed under a variety of different financing options. For example, as shown in FIG. 22, the system may be configured for a financing option of 48 months at 5.7% interest, or 60 months at 6.0%, or for a 48 month lease. Any or all of these may be displayed, and all may be simultaneously updated of optional items are selected or deselected.

In addition, the system may be integrated to a dealer management system or DMS. Often, data for a particular “deal” such a customer name, vehicle type and price, etc., are entered into a DMS. By having the present system integrated, the data for a particular deal may be selected, which can avoid the need for duplicate data entry.

While the invention has been illustrated and described in detail in the foregoing drawings and description, the same is to be considered as illustrative and not restrictive in character, it being understood that only illustrative embodiments thereof have been shown and described and that all changes and modifications that are within the scope of the following claims are desired to be protected.

All references cited in this specification are incorporated herein by reference to the extent that they supplement, explain, provide a background for or teach methodology or techniques employed herein.

What is claimed is:

1. An F&I items selection system for a vehicle having a base cost comprising:
a visual user interface having:
a base price area displaying the base cost of the vehicle without F&I items;
a with-F&I items price area displaying the base cost of the vehicle with selected F&I items;
icons representing F&I items,
a selected F&I items area for displaying icons of selected F&I items that have been selected;
an unselected F&I items area for displaying icons of unselected F&I items;
wherein:
a price is associated with each F&I item;
the icons may be selectively dragged into or out of the selected F&I items area;
the base cost of the vehicle with F&I items and the base cost of the vehicle without F&I items are each displayed in formats that include a periodic payment having an interest component;
means for displaying a signature area and capturing a handwritten signature; and
means for storing the captured handwritten signature, F&I items, and cost of the vehicle with selected F&I items.

2. The F&I items selection system of claim 1 further comprising:
a back-end system for selecting the F&I items that may be displayed by the F&I items selection system.

3. The F&I items selection system of claim 1 wherein at least some of the icons are responsive to a user input to display additional information regarding an F&I item.

4. The F&I items selection system of claim 1 wherein at least one of the icons is responsive to a user input that allows the price of an F&I item represented by an icon to be changed.

5. The F&I items selection system of claim 1 further comprising:
means responsive to user input for changing a down payment or periodic payment term for the vehicle.

6. The F&I items selection system of claim 1 further comprising means for integrating the system into a dealer management system.

7. An F&I items selection system for a vehicle having a base cost comprising:
a visual user interface having:
a base price area displaying the base cost of the vehicle without F&I items;
a with-F&I items area displaying the base cost of the vehicle with F&I items;
icons representing F&I items,
means for selecting and de-selecting each icon,
means for visually distinguishing icons that have been selected from icons that are not selected;
wherein:
a price is associated with each F&I item,
the base cost of the vehicle with F&I items displayed in the with-F&I items area is formatted as a periodic payment having an interest component and is automatically updated as icons are selected or de-selected;
means for displaying a signature area and capturing a handwritten signature; and
means for storing the captured handwritten signature, F&I items, and cost of the vehicle with selected F&I items.

8. The F&I items selection system of claim 7 wherein:
the automatic updating of the base cost of the vehicle with F&I items includes recalculating the interest component, and occurs as icons are dragged into or out of a selected F&I items area.

9. The F&I items selection system of claim 7 further comprising:
a recommend F&I items area displaying copies of a subset of the F&I items icons; and
a with-recommended F&I items cost area displaying the cost of the vehicle that includes the cost of the F&I items in the recommended F&I items area.

10. The F&I items selection system of claim 7 further comprising:
a back-end system for selecting the F&I items that may be displayed by the vehicle F&I items selection system.

11. The F&I items selection system of claim 7 wherein at least some of the icons are responsive to a user input to display additional information regarding an F&I item.

12. The F&I items selection system of claim 7 wherein at least one of the icons is responsive to a user input that allows the price of an F&I item represented by an icon to be changed.

13. The F&I items selection system of claim 7 further comprising:
means responsive to user input for changing a down payment or periodic payment term for the vehicle.

14. The F&I items selection system of claim 13 further comprising means for integrating the system into a dealer management system.
